(19) United States
(12) Patent Application Publication
(10) Pub. No.: US 2020/0005217 A1
(43) Pub. Date: Jan. 2, 2020

(54) PERSONALIZED CANDIDATE SEARCH RESULTS RANKING

(71) Applicant: Microsoft Technology Licensing, LLC, Redmond, WA (US)

(72) Inventors: Prakhar Sharma, Newark, CA (US); Apoorv Khandelwal, Dublin, CA (US); Lei Ni, Belmont, CA (US); Erik Buchanan, Sunnyvale, CA (US)

(73) Assignee: Microsoft Technology Licensing, LLC, Redmond, WA (US)

(21) Appl. No.: 16/023,870

(22) Filed: Jun. 29, 2018

(51) Int. Cl. G06Q 10/06; G06K 9/62; G06F 15/18; G06F 17/30

(52) U.S. Cl. CPC G06Q 10/063112; G06K 9/623; G06F 17/30867; G06K 9/6282; G06F 15/18

(57) ABSTRACT

The disclosed embodiments provide a system for processing data. During operation, the system determines impression discounting features for ordering a set of candidates that match parameters of a search from a recruiter, wherein the impression discounting features include a recruiter-candidate feature indicating interaction between the recruiter and a candidate and a candidate popularity feature indicating interaction between the candidate and a set of recruiters. Next, the system applies a machine learning model to the impression discounting features and features for the set of candidates to produce a first set of scores for personalizing a ranking of the set of candidates for the recruiter. The system then generates the ranking according to the first set of scores. Finally, the system outputs, to the recruiter, at least a portion of the ranking as search results of the search.

### BACKGROUND

### Field

The disclosed embodiments relate to techniques for ranking search results. More specifically, the disclosed embodiments relate to techniques for performing personalized ranking of candidate search results.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online networks may facilitate other types of activities and operations. For example, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

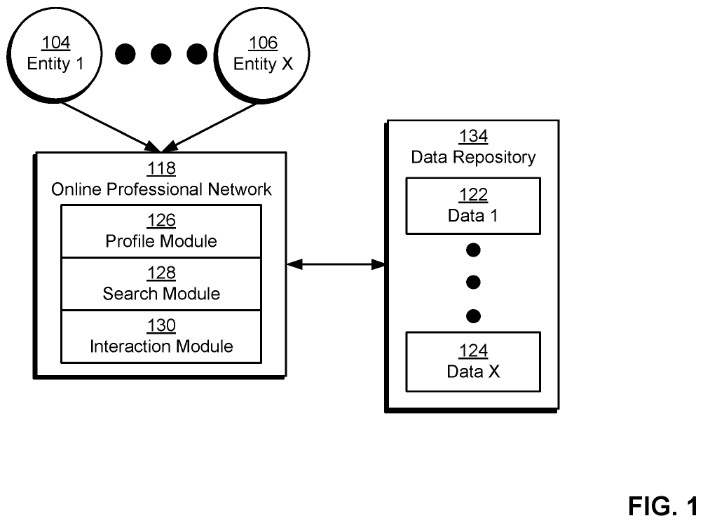

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, data in data repository 134 may be used to generate recommendations and/or other insights related to listings of jobs or opportunities within online professional network 118. For example, one or more components of the online professional network may track searches, clicks, views, text input, conversions, and/or other feedback during the entities' interaction with a job search and/or recruiter tool in the online professional network. The feedback may be stored in data repository 134 and used as training data for one or more machine learning models, and the output of the machine learning model(s) may be used to display and/or recommend a number of job listings to job seekers and/or a number of job candidates to recruiters in the online professional network.

More specifically, data in data repository 134 and one or more machine learning models are used to produce rankings of candidates for jobs or opportunities listed within or outside online professional network 118. The candidates may include users who have viewed, searched for, or applied to jobs, positions, roles, and/or opportunities, within or outside online professional network 118. The candidates may also, or instead, include users and/or members of online professional network 118 with skills, work experience, education, industries, demographic attributes, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). In turn, the machine learning model(s) may output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online professional network 118 and descriptions of the opportunities. The model(s) may further adjust the scores based on social and/or other validation of the candidates' profile data (e.g., endorsements of skills, recommendations, accomplishments, awards, etc.). The rankings may then be generated by ordering the candidates in descending order of score.

The rankings and/or associated insights may improve the quality of the candidates and/or recommendations of opportunities to the candidates, increase user activity with online professional network 118, and/or guide the decisions of the candidates and/or moderators involved in screening for or placing the opportunities (e.g., hiring managers, recruiters, human resources professionals, etc.). For example, one or more components of online professional network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, a ranking of candidates for a given set of job qualifications may be displayed as search results to a recruiter after the recruiter performs a search with the job qualifications included as parameters of the search.

On the other hand, the same ranking of candidates may be returned as search results for a given set of search parameters, regardless of the entity performing the search and/or the number of times the entity has performed the search. For example, a recruiter may repeatedly see the same candidates as search results for the same set of search parameters and/or similar sets of search parameters. Moreover, a different recruiter performing the same search and/or a similar search may also be exposed to the same search results. Such lack of variation in candidate search results may adversely affect the recruiters' ability to effectively find new candidates for positions, and may further cause multiple recruiters to contact the same candidate about potential opportunities, even if the candidate is not currently looking for a new job.

In one or more embodiments, user experiences of recruiters, candidates, and/or other entities involved in applying and/or hiring for jobs within and/or outside online professional network 118 are improved by performing personalized impression discounting of candidate search results. During such impression discounting, a candidate's position in search results shown to a recruiter may gradually decrease as the recruiter's views of the candidate in the search results increase. Moreover, changes to the candidate's position in the search results may be controlled to balance the consistency of search results for a given search with the recruiter's ability to discover new candidates that match the search criteria over time.

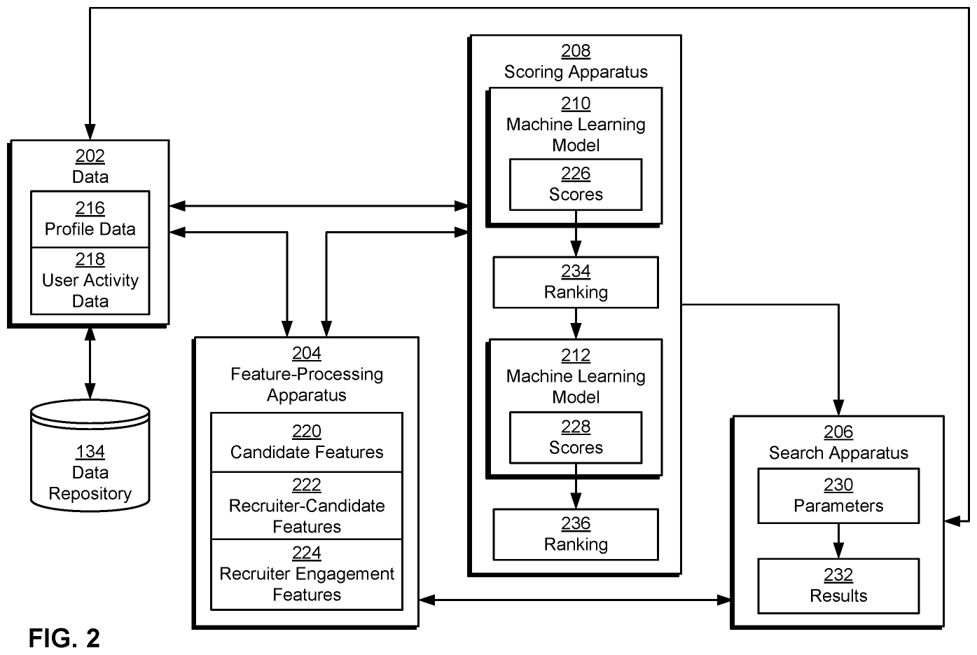

As shown in FIG. 2, impression discounting of candidate search results 232 involves the use of data 202 from data repository 134, which includes profile data 216 for members of a social network (e.g., online professional network 118 of FIG. 1) or other online community of users, as well as user activity data 218 that tracks the members' and/or candidates' activity within and/or outside the community. Profile data 216 may include data associated with member profiles in the community. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the community.

Attributes of the members may be matched to a number of member segments, with each member segment containing a group of members that share one or more common attributes. For example, member segments in the community may be defined to include members with the same industry, title, location, and/or language.

Connection information in profile data 216 may additionally be combined into a graph, with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of user interactions with one another and/or content associated with the community. For example, user activity data 218 may be used to track impressions, clicks, likes, dislikes, shares, hides, comments, posts, updates, conversions, and/or other user interaction with content in the community. User activity data 218 may also, or instead, track other types of community activity, including connections, messages, job applications, job searches, recruiter searches for candidates, interaction between candidates 116 and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users. Like profile data 216, user activity data 218 may be used to create a graph, with nodes in the graph representing community members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

Profile data 216, user activity data 218, and/or other data 202 in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

Data 202 in data repository 134 may be used to identify candidates that match parameters 230 of a search that is performed using a search apparatus 206. For example, search apparatus 206 may be provided by a recruiting module or tool that is associated with and/or provided by the online community. Search apparatus 206 may include checkboxes, radio buttons, drop-down menus, text boxes, and/or other user-interface elements that allow a recruiter and/or another entity involved in hiring or recruiting to specify parameters 230 related to candidates for a position and/or a number of related positions.

Parameters 230 include attributes that are desired or required by the position(s). For example, parameters 230 may specify thresholds, values, and/or ranges of values for an industry, location, education, skills, past positions, current positions, overall qualifications, title, seniority, keywords, awards, publications, patents, licenses and certifications, and/or other attributes or fields associated with profile data 216 for the candidates.

Search apparatus 206 and/or another component may query data repository 134 for profile data 216 that matches parameters 230. In response to the query, data repository 134 may return member identifiers and/or profile data 216 of candidates that match parameters 230. For example, data repository 134 may identify thousands to tens of thousands of candidates with profile attributes that meet or fit the criteria specified in parameters 230.

To improve the quality and/or relevance of search results 232 for a given set of search parameters 230, candidates that meet the criteria represented by parameters 230 are ordered in search results 232 based on features associated with the candidates and/or the recruiter performing the search. As shown in FIG. 2, a feature-processing apparatus 204 calculates the features using data 202 from data repository 134. Such calculations may occur on an offline, periodic, or batch-processing basis to produce features for a large number of candidates. Some or all features may also, or instead, be generated in an online, nearline, and/or on-demand basis based on recent search parameters (e.g., parameters 230) by recruiters and/or other users interacting with search apparatus 206.

In one or more embodiments, features used to produce results 232 include candidate features 220, recruiter-candidate features 222, and recruiter engagement features 224. Candidate features 220 may be generated for a set of candidates with attributes that match or meet parameters 230, recruiter-candidate features 222 may be generated for each candidate and the recruiter, and recruiter engagement features 224 may be generated for the recruiter.

Candidate features 220 may include features related to each candidate's compatibility with parameters 230. For example, candidate features 220 may include each candidate's name, school, title, seniority, employment history, skills, recommendations, endorsements, awards, honors, publications, and/or other attributes that relate, directly or indirectly, to search parameters 230 inputted by the recruiter. Candidate features 220 may also, or instead, include match scores between parameters 230 and the candidate's corresponding attributes (e.g., industry, location, skills, seniority, etc.), reputation scores for skills specified in parameters 230, and/or other measures of the candidate's qualifications compared with the corresponding criteria in parameters 230.

Candidate features 220 may further characterize the job-seeking behavior and/or preferences of each candidate. For example, candidate features 220 may include a job-seeker score that classifies the member's job-seeking status as a job seeker or non-job-seeker and/or estimates the member's level of job-seeking interest. In another example, candidate features 220 may include the amount of time since a candidate has expressed openness or availability for new opportunities (e.g., as a profile setting and/or job search setting). In a third example, candidate features 220 may include views, searches, applications, and/or other activity of the member with job postings in the social network and/or views or searches of company-specific pages in the social network.

Candidate features 220 may also, or instead, include measures of the candidate's popularity with recruiters and/or the candidate's willingness to interact with recruiters. For example, candidate features 220 related to a candidate's popularity may include the number of messages sent to the candidate by recruiters, the number of recruiter messages accepted by the candidate, a percentage of messages accepted by the candidate, message delivery settings of the candidate, and/or the number of times the candidate has been viewed in search results by recruiters.

Recruiter-candidate features 222 may describe interaction between the recruiter and each candidate and/or prior exposure of the recruiter to each candidate. For example, recruiter-candidate features 222 may include the number of times the recruiter has viewed a given candidate within the recruiting tool and/or in search results provided by search apparatus 206. In another example, recruiter-candidate features 222 may include an affinity score between the recruiter and the candidate, which is calculated using a matrix decomposition of messages sent and/or accepted between a set of recruiters and a set of candidates.

Recruiter engagement features 224 may characterize the recruiter's activity with search apparatus 206 and/or the recruiting tool. For example, recruiter engagement features 224 may include the number of candidate impressions the recruiter has across all searches, the number of candidate profiles viewed by the recruiter (e.g., after clicking on the corresponding search results and/or through other parts of the recruiting tool), the number of messages sent by the recruiter to candidates, and/or the number of messages sent by the recruiter that are accepted by the candidates. Recruiter engagement features 224 may also, or instead, include the recruiter's historical response rate to job applications and/or historical success rate in placing jobs.

In one or more embodiments, some or all candidate features 220, recruiter-candidate features 222, and/or recruiter engagement features 224 are calculated from profile data 216 and/or user activity data 218 that is collected over a configurable time window. For example, features that relate to job-seeking or hiring activities by recruiters and candidates and/or interaction between recruiters and candidates may be calculated over a 30-day sliding window. As a result, the sliding window may represent the “memory” of the system with respect to recent impressions, interactions, and/or other activity involving the recruiter and/or candidates. The features may also, or instead, be recalculated over a different configurable period (e.g., every seven days) to prevent scores 226-228, rankings 234-236, and results 232 produced from the features from changing too frequently.

In turn, the sliding window and/or values of the features may be used to perform impression discounting of candidates in search results 232 that are returned in response to search parameters 230 from a given recruiter. More specifically, a scoring apparatus 208 inputs candidate features 220, recruiter-candidate features 222, and recruiter-engagement features 224 into one or more machine learning models 210 to generate one or more sets of scores 226-228 for the candidates. Each set of scores 226-228 is then used to produce a corresponding ranking (e.g., rankings 234-236) of the candidates, and one or more rankings are used to populate search results 232 that are returned in response to a set of search parameters 230.

For example, machine learning models 210-212 may include decision trees, random forests, and/or gradient boosted trees that generate multiple rounds of scores 226-228 and/or rankings 234-236 for the candidates according to different sets of criteria and/or thresholds. Each score generated by one or both machine learning models 210-212 may represent the likelihood of a candidate accepting a message from the recruiter, given an impression of the candidate by the recruiter in search results 232. Thus, an improvement in the performance and/or precision of one or both machine learning models 210-212 may produce a corresponding increase in the rate of message acceptances by candidates after the candidates are viewed by recruiters in search results 232.

Continuing with the above example, scoring apparatus 208 may use machine learning model 210 to generate a first set of scores 226 from candidate features 220, recruiter-candidate features 222, and/or recruiter-engagement features 224 for all candidates that match parameters 230 (e.g., all candidates returned by data repository 134 in response to a query containing parameters 230). Scoring apparatus 208 may also generate ranking 234 by ordering the candidates by descending score from the first set of scores 226.

Next, scoring apparatus 208 may obtain a highest-ranked subset of candidates from ranking 234 (e.g., the top 1,000 candidates in ranking 234) and input additional candidate features 220, recruiter-candidate features 222, and/or recruiter-engagement features 224 for the highest-ranked subset of candidates into machine learning model 212. Scoring apparatus 208 may then obtain a second set of scores 228 from machine learning model 212 and generate ranking 236 by ordering the subset of candidates by descending score from the second set of scores 228. As a result, machine learning model 210 may perform a first round of scoring and ranking 234 and/or filtering of the candidates using a first of criteria, and machine learning model 212 may perform a second round of scoring and ranking 234 of a smaller number of candidates using a second set of criteria. The number of candidates scored by machine learning model 212 may be selected to accommodate performance and/or scalability constraints associated with generating results 232 in response to searches received through search apparatus 206.

Features that are used to perform personalized impression discounting of the candidates may be used with one or both machine learning models 210-212. For example, impressions by a recruiter of a specific candidate in search results, impressions by the recruiter of all candidate search results, impressions by the recruiter of all candidate profiles, messages sent by the recruiter, messages sent by the recruiter that have been accepted, impressions of a candidate's profile by all recruiters, messages received by the candidate, messages accepted by the candidate, and/or other types of activity involving recruiters and/or candidates may be inputted with other features into machine learning model 210. As a result, machine learning model 210 may generate scores 226 and ranking 234 based on previous impressions by the recruiter of a given candidate and/or recent behavior or popularity of the recruiter and/or candidate. Since a subset of candidates from ranking 234 is subsequently scored by machine learning model 212, impression discounting performed by machine learning model 210 may affect a candidate's inclusion in or exclusion from the subset. Moreover, additional impression discounting may be performed after ranking 234 by inputting scores 226 and/or some or all of the impression discounting features for the subset of candidates selected from ranking 234 into machine learning model 212. Consequently, scores 228 and the corresponding ranking 236 produced by machine learning model 212 may reflect impression discounting that is performed directly or indirectly by one or both machine learning models 210-212.

Finally, search apparatus 206 may use scores 226-228 and/or rankings 234-236 from scoring apparatus 208 to generate search results 232 that are displayed and/or outputted in response to the search. For example, search apparatus 206 may paginate some or all candidates in ranking 236 into subsets of search results 232 that are displayed as the recruiter scrolls through the search results 232 and/or navigates across screens or pages containing the search results 232.

By including impression discounting features with other features that are used to score and/or rank candidates with respect to a given set of search parameters 230, the system of FIG. 2 may learn complex interactions within the features that affect outcomes and/or performance metrics associated with candidate search results 232. At the same time, calculation of the impression discounting features according to a configurable time window and/or update period may allow each recruiter to be gradually exposed to a different ordering of candidates in search results 232 for the same and/or similar search parameters 230 while maintaining an overall consistency of results 232 across searches. Consequently, the system may improve technologies related to use of online networks, employment websites, and/or recruiting tools through network-enabled devices and/or applications, as well as user engagement, user experiences, and interaction through the online networks, employment websites, and/or recruiting tools.

Those skilled in the art will appreciate that the system of FIG. 2 may be implemented in a variety of ways. First, feature-processing apparatus 204, scoring apparatus 208, search apparatus 206, and/or data repository 134 may be provided by a single physical machine, multiple computer systems, one or more virtual machines, a grid, one or more databases, one or more filesystems, and/or a cloud computing system. Feature-processing apparatus 204, scoring apparatus 208, and search apparatus 206 may additionally be implemented together and/or separately by one or more hardware and/or software components and/or layers.

Second, a number of machine learning models and/or techniques may be used to generate scores 226-228 and/or rankings 234-236. For example, the functionality of each machine learning model may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features used to train the machine learning model. Multiple versions of a machine learning model may further be adapted to different subsets of candidates, recruiters, and/or search parameters 230 (e.g., different member segments in the community), or the same machine learning model may be used to generate one or more sets of scores (e.g., scores 226-228) for all candidates and/or recruiters in the community. Similarly, the functionality of machine learning models 210-212 may be merged into a single machine learning model that performs a single round of scoring and ranking of the candidates and/or separated out into more than two machine learning models that perform multiple rounds of scoring, filtering, and/or ranking of the candidates.

Third, the system of FIG. 2 may be adapted to generate search results 232 for various types of searches and/or entities. For example, the functionality of the system may be used to improve and/or personalize search results containing candidates for academic positions, artistic or musical roles, school admissions, fellowships, scholarships, competitions, club or group memberships, matchmaking, and/or other types of opportunities.

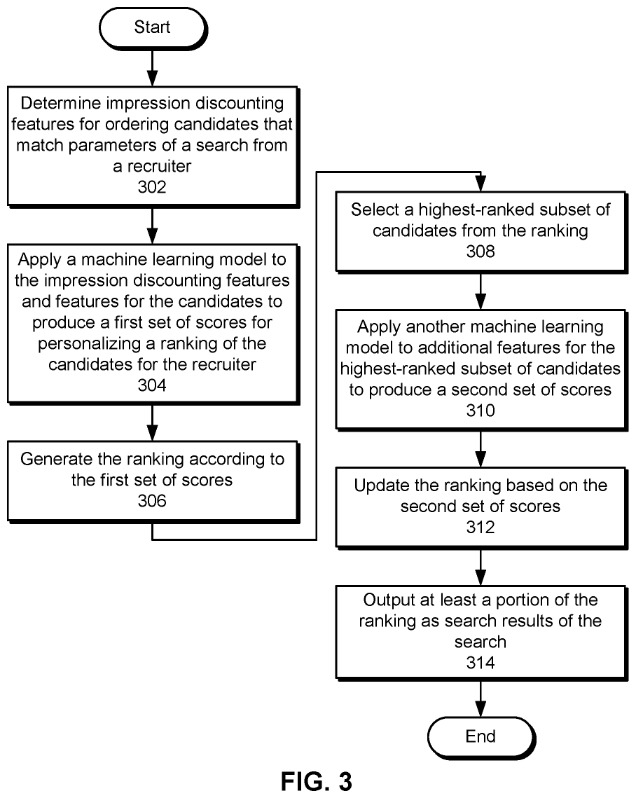

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, impression discounting features for ordering candidates that match parameters of a search from a recruiter are determined (operation 302). The impression discounting features may include recruiter-candidate features indicating interaction between recruiter-candidate pairs (e.g., the recruiter and each candidate matching the parameters of the search), candidate popularity features indicating interaction between each candidate and a set of recruiters (e.g., all recruiters using a recruiting tool), and/or recruiter engagement features indicating recruiting activity by the recruiter. The features may be calculated from activity data collected over a configurable time window and/or updated on a periodic basis.

The recruiter-candidate features may be calculated for the recruiter and each candidate that matches the search parameters, the recruiter engagement features may be determined for the recruiter, and the candidate popularity features may be determined for each candidate. The recruiter-candidate features may include a number of impressions of a candidate by the recruiter and/or an affinity score between the recruiter and the candidate. The candidate popularity features may include a number of impressions of a candidate by all recruiters, a number of messages from all recruiters to the candidate, and/or a number of messages accepted by the candidate. The recruiter engagement features may include a number of impressions of all candidates by the recruiter, a number of candidate profiles viewed by the recruiter, a number of messages sent by the recruiter to all candidates, and/or a number messages from the recruiter that are accepted.

Next, a machine learning model is applied to the impression discounting features and features for the candidates to produce a first set of scores for personalizing a ranking of the candidates for the recruiter (operation 304). For example, the candidate features may include a willingness of a candidate to accept a message from any recruiter, a match between a profile attribute of the candidate and the parameters of the search, a reputation score for a skill of the candidate, and/or a match in location between the candidate and the parameters. The machine learning model may be a gradient boosted tree and/or random forest that calculates, from the candidate features and impression discounting features, a score representing the likelihood that a candidate accepts a message from the recruiter, given an impression of the candidate by the recruiter.

The ranking is then generated according to the first set of scores (operation 306), and a highest-ranked subset of candidates is selected from the ranking (operation 308). For example, the candidates may be ranked by descending score from the first set of scores, and a pre-specified number of candidates with the highest scores may be selected from the ranking.

Another machine learning model is applied to additional features for the highest-ranked subset of candidates to produce a second set of scores (operation 310). For example, the other machine learning model may be another gradient boosted tree and/or random forest that is applied to features such as the first set of scores, a job-seeking status of a candidate, a match in industry between the candidate and the parameters of the search, and/or an engagement of the candidate with an online professional network and/or employment website. As a result, the first and second sets of scores may be generated by applying different sets of criteria to different sets of features.

Finally, the ranking is updated based on the second set of scores (operation 312), and at least a portion of the ranking is outputted as search results of the search (operation 314). For example, the subset of candidates may be reranked by descending score from the second set of scores, and some or all of the reranked candidates with the highest scores may be included in search results that are displayed, transmitted, and/or otherwise outputted to the recruiter.

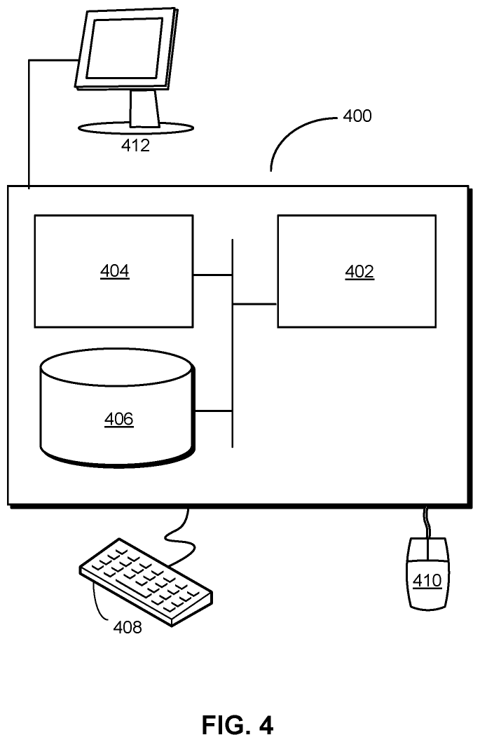

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a feature-processing apparatus, a scoring apparatus, and a search apparatus, one or more of which may alternatively be termed or implemented as a module, mechanism, or other type of system component. The feature-processing apparatus determines impression discounting features for ordering a set of candidates that match parameters of a search from a recruiter. Next, the scoring apparatus applies a machine learning model to the impression discounting features and features for the set of candidates to produce a set of scores for personalizing a ranking of the set of candidates for the recruiter. The impression discounting features may include a recruiter-candidate feature indicating interaction between the recruiter and a candidate, a candidate popularity feature indicating interaction between the candidate and a set of recruiters, and/or a recruiter engagement feature indicating recruiting activity by the recruiter. The scoring apparatus then generates the ranking by the scores. Finally, the search apparatus outputs, to the recruiter, at least a portion of the ranking as search results of the search.

In addition, one or more components of computer system 400 may be remotely located and connected to the other components over a network. Portions of the present embodiments (e.g., feature-processing apparatus, scoring apparatus, search apparatus, data repository, online professional network, etc.) may also be located on different nodes of a distributed system that implements the embodiments. For example, the present embodiments may be implemented using a cloud computing system that generates and personalizes candidate search results for searches performed by a set of remote recruiters.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems, impression discounting features for ordering a set of candidates that match parameters of a search from a recruiter, wherein the impression discounting features comprise a recruiter-candidate feature indicating interaction between the recruiter and a candidate and a candidate popularity feature indicating interaction between the candidate and a set of recruiters;
applying, by the one or more computer systems, a machine learning model to the impression discounting features and features for the set of candidates to produce a first set of scores for personalizing a ranking of the set of candidates for the recruiter;
generating the ranking according to the first set of scores; and
outputting, to the recruiter, at least a portion of the ranking as search results of the search.

2. The method of claim 1, further comprising:
selecting a highest-ranked subset of the candidates from the ranking;
applying an additional machine learning model to additional features for the highest-ranked subset of candidates to produce a second set of scores; and
updating the ranking based on the second set of scores prior to outputting at least the portion of the ranking as the search results of the search.

3. The method of claim 2, wherein the additional features comprise at least one of:
the first set of scores;
a job-seeking status of the candidate;
a match in industry between the candidate and the parameters; and
an engagement of the candidate with an online professional network.

4. The method of claim 1, wherein determining the impression discounting features comprises:
calculating the impression discounting features from activity data collected over a configurable time window.

5. The method of claim 1, wherein determining the impression discounting features comprises:
updating the impression discounting features on a periodic basis.

6. The method of claim 1, wherein the machine learning model comprises a random forest.

7. The method of claim 1, wherein the features for the set of candidates comprises at least one of:
a willingness of the candidate to accept a message from any recruiter;
a match between a profile attribute of the candidate and the parameters;
a reputation score for a skill of the candidate; and
a match in location between the candidate and the parameters.

8. The method of claim 1, wherein the candidate popularity feature comprises at least one of:
a number of impressions of the candidate by all recruiters;
a first number of messages from all recruiters to the candidate; and
a second number of messages accepted by the candidate.

9. The method of claim 1, wherein the recruiter-candidate feature comprises at least one of:
a number of impressions of the candidate by the recruiter; and
an affinity score between the recruiter and the candidate.

10. The method of claim 1, wherein the impression discounting features further comprise a recruiter engagement feature indicating recruiting activity by the recruiter.

11. The method of claim 10, wherein the recruiter engagement feature comprises at least one of:
a number of impressions of all candidates by the recruiter;
a number of candidate profiles viewed by the recruiter;
a first number of messages sent by the recruiter to all candidates; and
a second number messages from the recruiter that are accepted.

12. A system, comprising:
one or more processors; and
memory storing instructions that, when executed by the one or more processors, cause the system to:
determine impression discounting features for ordering a set of candidates that match parameters of a search from a recruiter, wherein the impression discounting features comprise a recruiter-candidate feature indicating interaction between the recruiter and a candidate, a candidate popularity feature indicating interaction between the candidate and a set of recruiters, and a recruiter engagement feature indicating recruiting activity by the recruiter;
apply a machine learning model to the impression discounting features and features for the set of candidates to produce a first set of scores for personalizing a ranking of the set of candidates for the recruiter;
generate the ranking according to the first set of scores; and
output, to the recruiter, at least a portion of the ranking as search results of the search.

13. The system of claim 12, wherein the memory further stores instructions that, when executed by the one or more processors, cause the system to:
select a highest-ranked subset of the candidates from the ranking;
apply an additional machine learning model to additional features for the highest-ranked subset of candidates to produce a second set of scores; and
update the ranking based on the second set of scores prior to outputting at least the portion of the ranking as the search results of the search.

14. The system of claim 13, wherein the additional features comprise at least one of:
the first set of scores;
a job-seeking status of a candidate;
a match in industry between the candidate and the parameters; and
an engagement of the candidate with an online professional network.

15. The system of claim 12, wherein determining the impression discounting features comprises at least one of:
calculating the impression discounting features from activity data collected over a configurable time window; and
updating the impression discounting features on a periodic basis.

16. The system of claim 12, wherein the features for the set of candidates comprises at least one of:
a willingness of a candidate to accept a message from any recruiter;
a match between a profile attribute of the candidate and the parameters;
a reputation score for a skill of the candidate; and
a match in location between the candidate and the parameters.

17. The system of claim 12, wherein the candidate popularity feature comprises at least one of:
a number of impressions of a candidate by all recruiters;
a first number of messages from all recruiters to the candidate; and
a second number of messages accepted by the candidate.

18. The system of claim 12, wherein the recruiter-candidate feature comprises at least one of:
a number of impressions of a candidate by the recruiter; and
an affinity score between the recruiter and the candidate.

19. The system of claim 12, wherein the recruiter engagement feature comprises at least one of:
a number of impressions of all candidates by the recruiter;
a number of candidate profiles viewed by the recruiter;
a first number of messages sent by the recruiter to all candidates; and
a second number messages from the recruiter that are accepted

20. A non-transitory computer-readable storage medium storing instructions that when executed by a computer cause the computer to perform a method, the method comprising:
determining impression discounting features for ordering a set of candidates that match parameters of a search from a recruiter, wherein the impression discounting features comprise a recruiter-candidate feature indicating interaction between the recruiter and a candidate and a candidate popularity feature indicating interaction between the candidate and a set of recruiters;
applying a machine learning model to the impression discounting features and features for the set of candidates to produce a first set of scores for personalizing a ranking of the set of candidates for the recruiter;
generating the ranking according to the first set of scores; and
outputting, to the recruiter, at least a portion of the ranking as search results of the search.
